(19) United States
(12) Patent Application Publication
(10) Pub. No.: US 2009/0085856 A1
(43) Pub. Date: Apr. 2, 2009

(54) Display Device

(75) Inventors: Yuuki OKADA, Tama (JP); Kikuo Ono, Mobara (JP); Yoshihisa Ooishi, Yokohama (JP); Junichi Maruyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/139,598

(22) Filed: Jun. 16, 2008

(30) Foreign Application Priority Data
Sep. 28, 2007 (JP) 2007-253024

(51) Int. Cl. G09G 3/36

(52) U.S. Cl. 345/94

(57) ABSTRACT

An overdrive device corrects IN data by referring to a look-up table based on IN data, ODA data outputted from the look-up table, which is previous by one frame and ODB data outputted from the look-up table, which is previous by two frames.

### CLAIM OF PRIORITY

The present application claims priority from Japanese application serial no. 2007-253024 filed on Sep. 28, 2007, the content of which is hereby incorporated by reference into this application.

### BACKGROUND OF THE INVENTION

1. Field of the Invention

This invention relates to a display device displaying video and a drive method thereof, and particularly relates to a display device and a drive method in which response characteristics of pixels are improved by an overdrive technology.

2. Background Art

As a technology for improving response speed of liquid crystal, there exists an overdrive technology. The overdrive technology is a technology in which correction data corresponding to a difference between continuous two frames of input display data at the same position in a one-frame picture is added to or subtracted from the input display data, and display data higher than the input display data is given to the liquid crystal, thereby shortening response time of the liquid crystal reaching the input display data.

As a related art, in U.S. Patent Application No. 2006-0209095 (JP-A-2005-37749), there is disclosed a technique in which a suitable overdrive look-up table is selected based on comparison between a pixel tone value in a frame which is previous to a frame to be displayed next by one frame and a pixel tone value in a frame which is previous to the frame to be displayed next by two frames, and an overdrive tone value is determined by using the selected overdrive look-up table, thereby efficiently improving quality of a dynamic screen as compared with the method in the related art in which a static overdrive look-up table is merely used. Specifically, an overdrive device includes storage means and overdrive selection means, in which the storage means stores pixel tone values of pixels in respective frames and the overdrive selection means is connected to the storage means, selecting at least one overdrive look-up table to be used based on comparison between a pixel tone value of a pixel in a frame which is previous to a frame to be displayed next by two frames and a pixel tone value of a pixel in a frame which is previous to the frame to be displayed next by one frame, further outputting an overdrive tone value by referring to the selected overdrive look-up table based on a pixel tone value of a pixel in a frame which is displayed next and a pixel tone value of the pixel in a frame which is previous by one frame.

In a JP-A-2005-37749, there is disclosed a technique in which, in a case that, when the overdrive corresponding to previous pixel data has not been sufficiently performed, overdrive pixel data corresponding to present pixel data of a next frame is generated, overdrive pixel data is generated in consideration of overflow of the previous pixel and is supplied to a liquid crystal display device, thereby applying data by adding data in a next frame, the drive of which was insufficient in the previous frame to improve the response speed of liquid crystal. Specifically, there are provided an overflow detection unit detecting the generation of overflow when overdrive pixel data is generated in an overdrive pixel data generation unit, which is depart from the range of values acceptable by the liquid crystal display device and a limiter unit transmits overdrive pixel data to the liquid crystal display device by limiting the overdrive pixel data to boundary values within the range of values when the overflow is detected by the overflow detection unit, and when overdrive pixel data of the pixel in a next frame is generated, receiving the detection of generation of overflow by the overflow detection unit in the overdrive pixel data generation unit, overdrive pixel data is generated in consideration of data which has been limited by the limiter unit in the overflow pixel data at this time.

### SUMMARY OF THE INVENTION

Hereinafter, FIG. 1 and FIG. 2 will be explained. In the following description, an input tone value in a frame unit is represented as IN data, and combination of IN data in the continuous frames is represented as video data.

FIG. 1A and FIG. 1B show certain video data respectively, in which the horizontal axis denotes time (frame) and the vertical axis denotes IN data. FIG. 2A and FIG. 2B show waveforms of liquid crystal response corresponding to FIG. 1A and FIG. 1B respectively, in which the horizontal axis denotes time (frame) and the vertical axis denotes luminance.

Assume that IN data at the (N-3)th frame, the (N-2)th frame, the (N-1)th frame and the Nth frame are 0, D1, D2 and D3, and assume that IN data at the (N-3)th frame, the (N-2)th frame, the (N-1) frame and the Nth frame are D4, D5, D6 and D7 and that the relation of D1=D2=D5=D6, and D3=D4=D7 are satisfied. Also, assume that an overdrive tone value in FIG. 1A is OD1, and an overdrive tone value in FIG. 1B is OD2, and that Ym (an integer satisfying m:1≦m≦7) represents a desired luminance value corresponding to IN data Dm (an integer satisfying m:1≦m≦7) in FIG. 1A and FIG. 1B. In this case, an relational expression OD1=OD2 is derived when using the technique of U.S. Patent application No. 2006-0209095 (JP-A-2005-37749).

Hereinafter, problems of the related art will be explained with reference to FIG. 1 and FIG. 2.

In the case of liquid crystal with low response speed, the liquid crystal response in the related art reaches the desired luminance in the Nth frame with respect to video data of FIG. 1A as shown in FIG. 2A. On the other hand, the liquid crystal response does not reach the desired luminance in FIG. 2B through values of IN data in the (N-2)th, the (N-1)th and the N-th frame are the same as FIG. 1A. The reasons thereof will be explained in detail.

Assume that a look-up table is set so that the liquid crystal response reaches the desired luminance of each frame in one frame period at the (N-2)th, the (N-1)th and the Nth frame with respect to the video data of FIG. 1A as shown in FIG. 2A. When overdrive data in the Nth frame of FIG. 1B is determined, the same data as in the case of FIG. 1A is referred in the (N-2)th, the (N-1)th and the Nth frame, however, video data of FIG. 1B was not optimized in two frame periods of the (N-1)th frame and the (N-1)th frame because of the delay of response speed and the overdrive data for reaching the desired luminance being less than 0 tone, therefore, reaching luminance of liquid crystal response in the (N-1)th frame does not reach the desired luminance (Y6) as shown in FIG. 2B. Accordingly, disagreement of start luminance in the (N-1)th frame occurs between FIG. 1A and FIG. 1B, therefore, reaching luminance of liquid crystal response in the Nth frame of FIG. 1B does not agree with the desired luminance (Y7) according to a relational expression of OD1=OD2. In the case of liquid crystal whose response speed is low as described above, it is difficult to acquire overdrive data whereby liquid crystal response reaches the desired luminance with respect to IN data of continuous two frames of 0 tone or in the vicinity of 255 tone, and even for overdrive data in the following frames, luminance values different from the desired luminance will be acquired.

In a technique disclosed in JP-A-2005-37749, overflow is reflected to the next picture data, it is difficult to acquire overdrive data whereby liquid crystal response reaches the desired luminance with respect to IN data of continuous two frames of 0 tone or in the vicinity of 255-tone, and even for overdrive data in the following frames, luminance values different from the desired luminance will be acquired as same as U.S. Patent application No. 2006-0209095 (JP-A-2005-37749).

An object of the invention is to provide a device and a method capable of obtaining suitable overdrive data even when video data largely varies between frames (particularly, in the case of varying in the opposite direction).

The invention corrects video data inputted to an overdrive device based on video data inputted to the overdrive device and video data which is previous to the data by one frame or by one or more frames, which has been corrected by the overdrive device.

According to the invention, data after the overdrive processing is used as video data which is previous by one frame or by two or more frames to be compared with respect to video data before the overdrive processing, therefore, suitable overdrive data can be obtained even when video data largely varies between frames (particularly, the case of varying in the opposite direction).

Also according to the invention, overdrive data in the (N-2)th frame and the (N-1)th frame is different in FIG. 1A and FIG. 1B, therefore, it is possible to realize high-quality moving pictures by setting combination of these values so as to acquire overdrive data for reaching the desired luminance.

### BRIEF DESCRIPTION OF THE DRAWINGS

FIG. 1A and FIG. 1B are graphs showing video data indicating effectiveness of a related art and video data indicating problems of the related art;

FIG. 2A and FIG. 2B are graphs showing liquid crystal response according to video data of FIG. 1A and FIG. 1B;

FIG. 3A and FIG. 3B are views of a display device according to a first embodiment;

FIG. 4 is a configuration view of a look-up table used in the first embodiment;

FIG. 5 is an operation timing chart of the display device according to the first embodiment;

FIG. 6 is a graph of liquid crystal response when executing the first embodiment with respect to video data which is a problem of a related art;

FIG. 7 is a graph of video data showing a problem when executing the first embodiment;

FIG. 8 is a graph of liquid crystal response corresponding to video data of FIG. 7;

FIG. 9 is a view of a display device according to a second embodiment;

FIG. 10 is a configuration view of a look-up table used in the second embodiment;

FIG. 11 is a graph of liquid crystal response when executing the second embodiment with respect to video data of FIG. 7;

FIG. 12A and FIG. 12B are views of a display device according to a third embodiment;

FIG. 13 is a configuration view of a two-dimensional look-up table used in the third embodiment; and

FIG. 14 is an operation timing chart of the display device according to the third embodiment.

### DESCRIPTION OF THE PREFERRED EMBODIMENTS

Hereinafter, the first to third embodiments of the invention will be explained.

### Embodiment 1

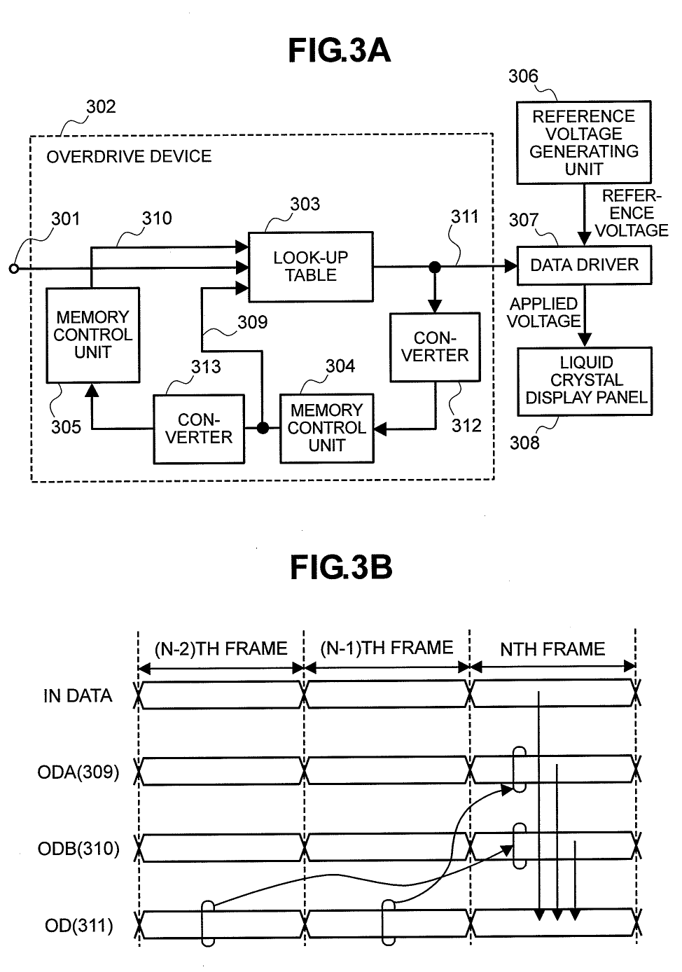

A configuration of a first embodiment of the invention will be explained with reference to FIG. 3 to FIG. 6.

First, FIG. 3A shows a block diagram showing a configuration of a display device used when executing the embodiment, in which 301 denotes an input video terminal to which video data is inputted, 302 denotes an overdrive device performing overdrive processing to the video data, 303 denotes a look-up table (reference information) used for the overdrive processing, 304, 305 denote memory control units storing video data and outputting the data after a prescribed period of time has passed, 306 denotes a reference voltage generating unit generating reference voltages corresponding to the number of tone numbers which can be represented by video data, 307 denotes a data driver selecting reference voltage according to the tone represented by video data, 308 denotes a liquid crystal display panel in which plural pixels are arranged in a matrix state, 309, 310, and 311 denote data buses respectively, and 312, 313 denote converters conversing video data respectively. FIG. 3B shows a timing chart of overdrive data to be acquired and reference data included in the look-up table 303. The look-up table 303 is housed in an overdrive device 302 or a memory outside the overdrive device 302, such as an EEPROM or a register.

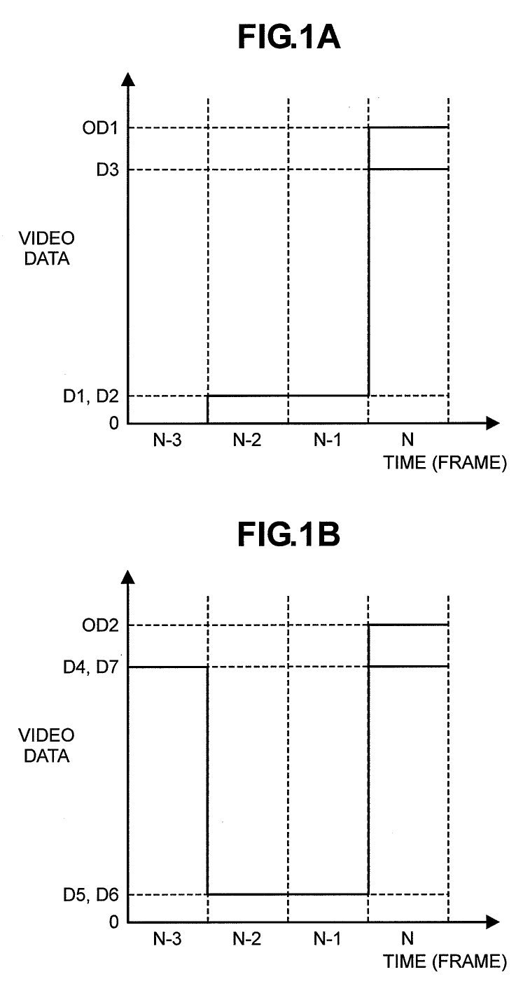

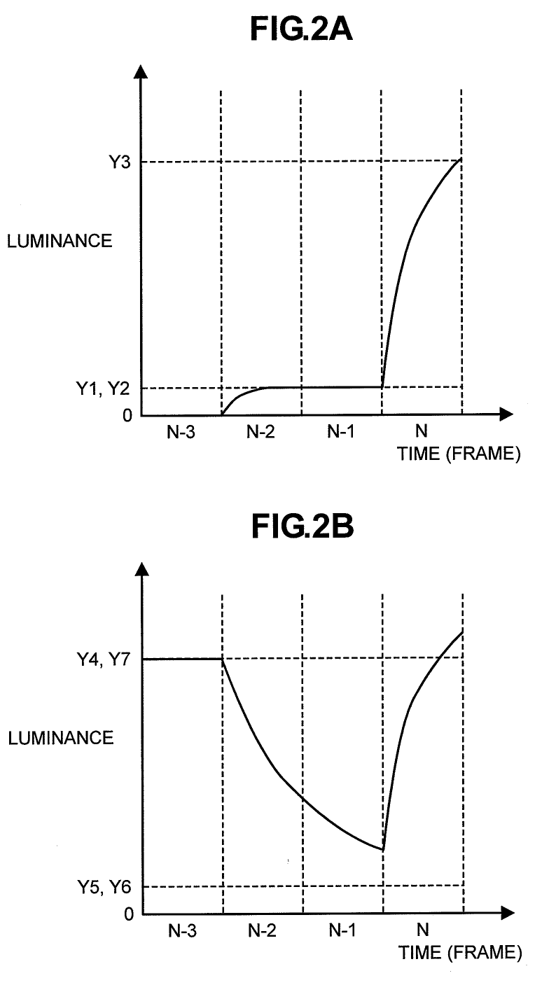

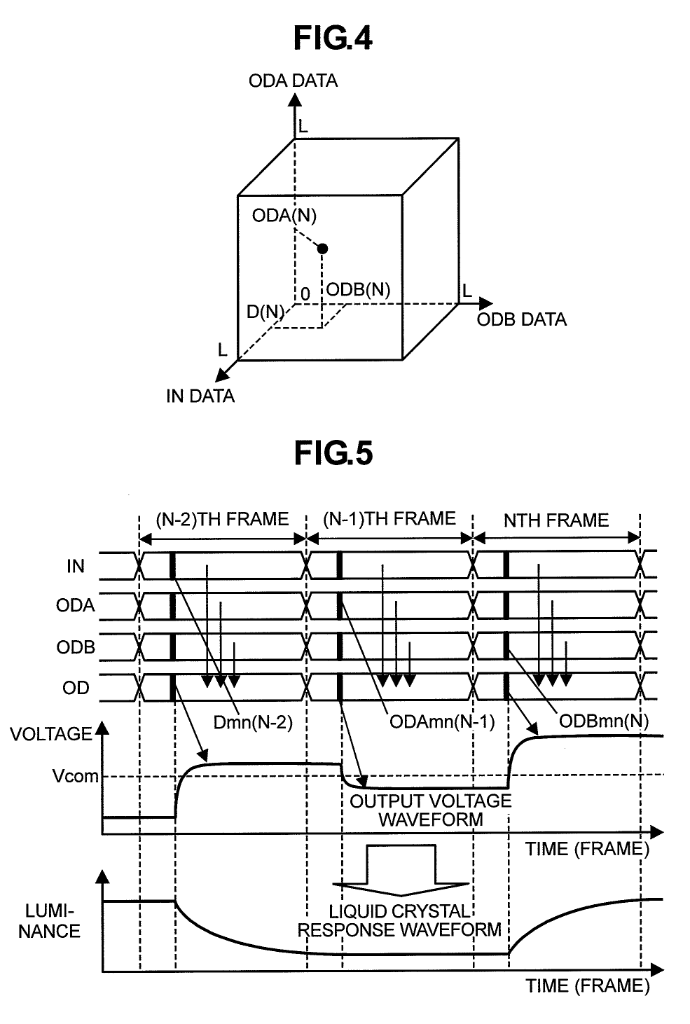

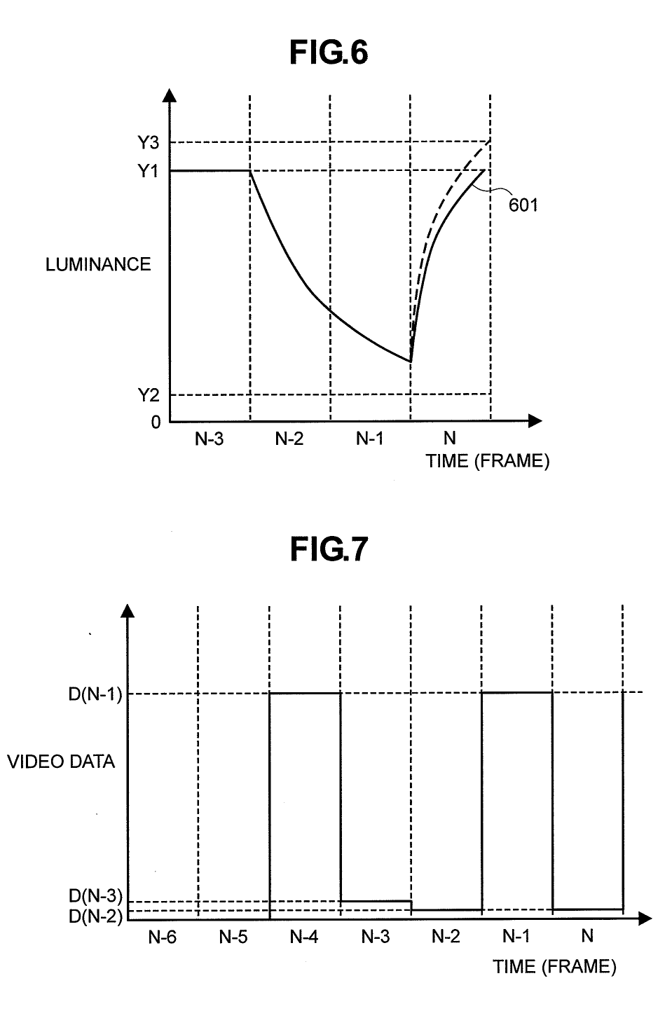

FIG. 4 is a configuration view of the look-up table 303, FIG. 5 shows operation timing in the overdrive device 302, and FIG. 6 shows liquid crystal response when the embodiment is executed with respect to video data of FIG. 1B.

Next, the entire flow of the embodiment will be briefly explained.

The input video terminal 301 inputs IN data (video data) having color tones or tone information corresponding to screen display, which is outputted from a not-shown external system (for example, a TV decoder, a cellular phone body, and a PC body). The video data are converted into voltage corresponding to liquid crystal response by the overdrive device 302, the reference voltage generating unit 306 and the data driver 307 and applies the voltage to the liquid crystal display panel 308 to display video. In the embodiment, the tone information included in display data is an L-tone (“L” is an integer of 1 or more).

According to the above, configurations of the overdrive device 302 and internal blocks thereof will be explained in detail.

The overdrive device 302 acquires video data (hereinafter, represented as OD data) after overdrive processing in the Nth frame from the look-up table 303 based on IN data in the Nth frame and respective video data after the correction in a frame which is previous by one frame ((N-1) th frame) and in a frame which is previous by two frames ((N-2)th frame) (hereinafter, represented as ODA data and ODB data), and transfers the data to the data driver 307. The OD data is data in which correction data has been already added or subtracted with respect to IN data. The correction data is obtained from the relation of the difference between IN data and ODA data, the difference between IN data and ODB data and the difference between ODA data and ODB data. In the overdrive device 302, ODA data is transferred to the data bus 309, ODB data is transferred to the data bus 310 and OD data is supplied to the data bus 311, respectively. From that point, they are expressed as ODA (309), ODB (310) and OD (311) in the timing chart of FIG. 3B.

The look-up table 303 is formed by a three-dimensional map of IN data, ODA data and ODB data as shown in FIG. 4. D(N), ODA(N) and ODB(N) denote the IN data, the ODA data and ODB data referred to for acquiring Nth frame OD data. According to the three-dimensional map, OD data for driving the liquid crystal display panel 308 is acquired by referring to IN data, ODA data and ODB data. The IN data, the ODA data and the ODB data forming the three-dimensional map take values from 0 tone to L tone, and OD data is outputted as “0” in the case of less than 0-tone and is outputted as “L” in the case of L-tone or more. The 0-tone is the lower limit value of IN data as well as the lower limit value of reference voltage. The L-tone is the upper limit value of IN data as well as the upper limit value of reference voltage. In the case that the OD data is less than the 0-tone or more than L-tone, there does not exist reference voltage corresponding to the OD data, therefore, OD data is outputted as O-tone or L-tone. Conditions of OD (N) set in the look-up table when OD data of the Nth frame is OD (N) will be explained as follows. In the case that ODA(N), ODB(N), and D(N) satisfies the relation of 0<ODA(N)<255 as well as 0<ODB(N)<255 as well as ODB(N)<D(N)<255, OD(N) is set in the range which satisfies D(N)<OD(N). In the case that the relation of 0<ODA(N)<255 as well as 0<ODB(N)<255 as well as ODB(N)=D(N) is satisfied, OD(N) is set so as to satisfy D(N)=OD(N). Next, the setting of OD(N) in the case of ODA(N)=ODB(N)=0 will be explained. For example, when the optimum value of OD(N) with respect to ODA(N)=15, ODB(N)=10, D(N)=128 (under the condition that D(N-2)=D(N-1)=10 is satisfied) is 135, OD(N) which satisfies the relation of OD(N)<135 is set with respect to ODA(N)=ODB(N)=0, D(N)=128 (under the condition that D(N-2)=D(N-1)=10 is satisfied). When the look-up table in which all data to be referred is input data such as D(N-2), D(N-1), D(N) is used as in the related art, OD(N)=135 is outputted with respect to the case of ODA(N)=0, ODB (N)=0, it is difficult to avoid problems that the desired luminance is not satisfied, however, it is possible to avoid the problem by setting OD(N) within the range of OD(N)<135.

The memory control units 304, 305 output the transferred video data after holding the data during one-frame period. The memory control unit 304 writes the OD data transferred from the look-up table 303, and transfers the data to the memory control unit 305 and the look-up table 303 after holding it during one-frame period. The memory control unit 305 writes ODA data transferred from the memory control unit 304, and transfers the data to the look-up table 303 after holding the data during one-frame period. It is preferable that the memory control units 304, 305 include a frame memory which can hold video data during at least one-frame (one-screen) period and a memory controller controlling writing and reading of video data with respect to the frame memory.

The converters 312, 313 have a bit reduction function respectively for preventing a circuit scale from increasing, reducing a lower 1-bit (1 is an integer satisfying 0<1<L) and outputting data of (L−1)-bit. Therefore, it is possible in the embodiment or embodiments below, to realize bit reduction by using these converters. It is also preferable that the converters 312, 311 do not exist. The reference voltage generating unit 306 generates reference voltage in consideration of applied voltage-transmittance characteristics which is characteristics peculiar to the liquid crystal display panel 308. The reference voltage generating unit 306 generates the number of reference voltages corresponding to the number of tones which can be represented by IN data and outputs them. For example, when IN data is 8-bit and the number of tones which can be represented by IN data is 256, reference voltages having different levels of 256 kinds are generated.

The data driver 307 inputs reference voltages received from the reference voltage generating unit 306 and OD data transferred from the look-up table 303, selects reference voltage corresponding to the tone represented by the video data and applies the selected reference voltage to respective pixels on the liquid crystal display panel 308 selected by a scanning driver which scans pixel rows (scanning lines) on the liquid crystal display panel 308 through signal lines, according to video data.

The liquid crystal display panel 308 includes plural signal lines and plural scanning lines crossing the signal lines, in which pixels are arranged corresponding to respective intersections of plural signal lines and plural scanning lines. Transistors for switching are arranged at respective pixel units. The liquid crystal display panel 308 is a so-called active-matrix type flat panel. A source of the transistor is connected to a pixel electrode and a gate of the transistor is connected to a scanning line, the difference between applied voltage of the pixel electrode and applied voltage of a common electrode at the opposite side (hereinafter, represented as Vcom voltage) controls liquid crystal sealed between the pixel electrode and the common electrode to control transmittance of light from a back light and to display tones (luminance) represented by video data. The polarity (positive polarity and negative polarity) of applied voltage of the pixel electrode with respect to applied voltage of the common electrode may be inverted at each one-frame period.

Hereinafter, description will be made on the assumption that a resolution of the liquid crystal display panel 201 is I×J, IN data of a pixel (i, j) (1≦i≦I, 1≦j≦J) in a Mth frame is Dij (M), ODA data of the pixel (i, j) in the Mth frame which is transferred from the memory control unit 304 to the memory control unit 305 is ODAij (M), ODB data of the pixel (i, j) in the Mth frame which is transferred from the memory control unit 305 to the look-up table 303 is ODBij (M), and the OD data of the pixel (i, j) in the Mth frame which is transferred from the look-up table 303 to the data driver 307 is ODij(M). In addition, it is regarded that the relation of ODij(M-2)=ODAij(M-1)=ODBij(M) is satisfided.

Next, operation timing in the display device in the first embodiment will be explained with respect to FIG. 5.

FIG. 5 is a timing chart of the operation of the overdrive device 302. For example, ODmn (N-1) in a pixel (m, n) (1≦m≦I, 1≦n≦J) in the (N-1)th frame is acquired based on Dmn (N-1), ODAmn (N-1) transferred from the memory control unit 304 and ODBmn (N-1) transferred from the memory control unit 305. The memory control unit 304 writes the acquired ODmn (N-1) and holds it during one-frame period as well as reads ODAmn (N) and transfers it to the memory control unit 305. The memory control unit 305 writes the transferred ODAmn (N) and holds it during one-frame period. The memory control unit 304 reads OD data ODAmn(N) and the memory control unit 305 reads OD data ODBmn(N) at the timing when IN data Dmn(N) transferred from the input video terminal is inputted to the look-up table 303, and transfers them to the look-up table 303. According to the same flow, ODmn(N) is outputted from the look-up table 303 based on Dmn(N), ODAmn(N), and ODBmn(N). Waveforms in the drawing show an output voltage waveform (upper) to the pixel (m, n) and the liquid crystal response corresponding to the output voltage (lower).

According to the above operation, when the embodiment is executed with respect to video data of FIG. 1A and FIG. 1B, OD data in the (N-2)th frame and the (N-1) the frame is different in FIG. 1A and FIG. 1B based on the above-described setting conditions of the look-up table, therefore, OD data in the Nth frame is also different in FIG. 1A and FIG. 1B. Therefore, liquid crystal response reaches the desired luminance corresponding to IN data as shown by 601 in FIG. 6 and desired luminance can be obtained in the following frames by the combination of IN data, ODA data and ODB data included in the look-up table 303 regardless of the video data of FIG. 1B, as a result, high picture quality can be realized.

Consequently, in the case that a value of IN data in the (N-2)the frame is different from a value of IN data in the Nth frame and a value of IN data of (N-1)th frame even when the value of IN data in the Nth frame and the value of IN data in the (N-1)th frame are the same, a value of OD data in the Nth frame outputted from the overdrive device 302 will be different from the value of IN data in the Nth frame, and a value of data in the Nth frame displayed on the liquid crystal display panel 308 will be also different from the value of IN data in the Nth frame.

Furthermore, even when the value of IN data in the Nth frame, the value of IN data in the (N-1)th frame and the value of IN data in the (N-2)th frame are the same, OD data after the overdrive processing in the (N-1)th frame, namely, ODA data, or OD data after the overdrive processing in the (N-2) th frame, namely, ODB data are used for obtaining OD data of Nth frame, therefore, in the case that a value of IN data in the (N-3)th frame is different from the value of IN data in the Nth frame, the value of IN data in the (N-1)th frame and the value of IN data in the (N-2)th frame (the case that values of video data of continuous three frames are the same and a value of video data which is previous by one frame is different), OD data after the overdrive processing in the (N-1) the frame, namely, a value of ODA data or OD data after the overdrive processing in the (N-2)th frame, namely, the ODB data is different from a value of IN data in the (N-1)th frame or a value of IN data of the (N-2)th frame, therefore, a value of OD data of the Nth frame will be different from the value of IN data in the Nth frame, and a value of Nth frame displayed on the liquid crystal display panel 308 will be also different from the value of IN data of the Nth frame. Accordingly, when the value of IN data in the Nth frame, the value of IN data in the (N-1)th frame and the value of IN data in the (N-2)th frame are the same as well as the value of IN data in the (N-3)th frame is different from the value of IN data in the Nth frame, the value of IN data in the (N-1)th frame and the value of IN data in the (N-2)th frame (the case that values of video data of continuous three frames are the same and the value of video data which is previous by one frame is different), luminance displayed by data of Nth frame which is displayed on the liquid crystal display panel 308 will be different from luminance displayed by data of the Nth frame displayed which is displayed on the liquid crystal display panel 308 when the value of IN data in the Nth frame, the value of IN data in the (N-1)th frame, the value of IN data in the (N-2)th frame and the value of IN data in the (N-3)th frame are the same (the case that values of video data of four continuous frames are the same).

Similarly, even when the value of IN data in the Nth frame, the value of IN data in the (N-1)th frame, the value of IN data in the (N-2)th frame and the value of IN data in the (N-3)th frame are the same, in the case that a value of IN data in the (N-4)th frame is different from the value of IN data in the Nth frame, the value of IN data in the (N-1)th frame, the value of IN data in the (N-2)th frame and the value of IN data in the (N-3)th frame (the case that values video data of continuous four frames are the same and the value of video data which is previous by one frame is different), the value of data in the Nth frame displayed on the liquid crystal display panel 308 is also different from the value of IN data in the Nth frame. Therefore, in the case that the value of IN data in the Nth frame, the value of IN data in the (N-1)th frame, the value of IN data in the (N-2)th frame and the value of IN data in the (N-3)th frame are the same as well as the value of IN data in the (N-4)th frame is different from the value of IN data in the Nth frame, the value of IN data in the (N-1)th frame, the value of IN data in the (N-2)th frame and the value of IN data in the (N-3)th frame (the case that values of video data of continuous four frames are the same the value of video data which is previous by one frame is different), luminance displayed by data of the Nth frame displayed on the liquid crystal display device 308 will be different from luminance displayed by data of the Nth frame displayed on the liquid crystal display device 308 when the value of IN data in the Nth frame, the value of IN data in the (N-1)th frame, the value of IN data in the (N-2)th frame, the value of IN data in the (N-3)th frame and the value of IN data in the (N-4)th frame are the same (the case that values of continuous five frames of video data are the same).

In the technique of U.S. Patent application No. 2006-0209095 (JP-A-2005-37749), only N data is used, therefore, it is considered that, when the value of IN data in the Nth frame, the value of IN data in the (N-1) frame, the value of IN data in the (N-2) frame are the same, the value of OD data in the Nth frame will be the same as the value of IN data of the Nth frame regardless of values of IN data in the (N-3)th frame and IN data in the (N-4)th frame.

The invention can be applied to the case of four frames or more, not limited to the three frames. In addition, the invention can be applied to display devices other than the liquid crystal display device. It is also preferable to use a logical operation circuit calculating OD data from IN data, ODA data and ODB data, instead of using the look-up table.

### Embodiment 2

When the first embodiment of the invention described above is executed with respect to, for example, video data of FIG. 7, there is concern that liquid crystal response does not obtain the desired luminance corresponding to IN data at the point of a certain frame and will diverge in the following frames. In the embodiment, internal blocks of the overdrive device 302 used in the first embodiment are improved to prevent divergence.

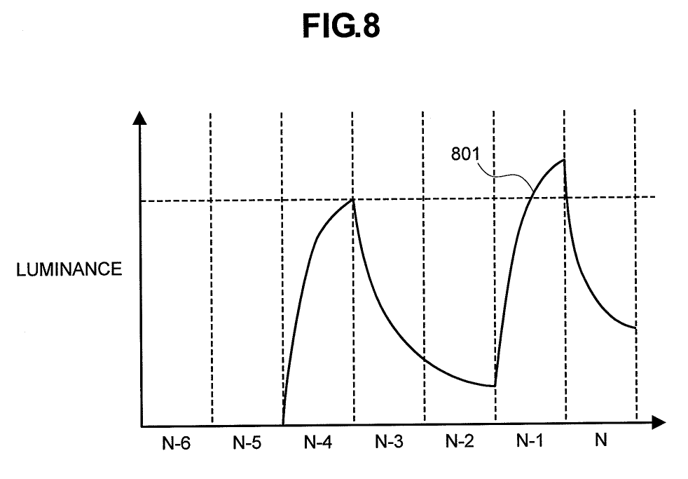

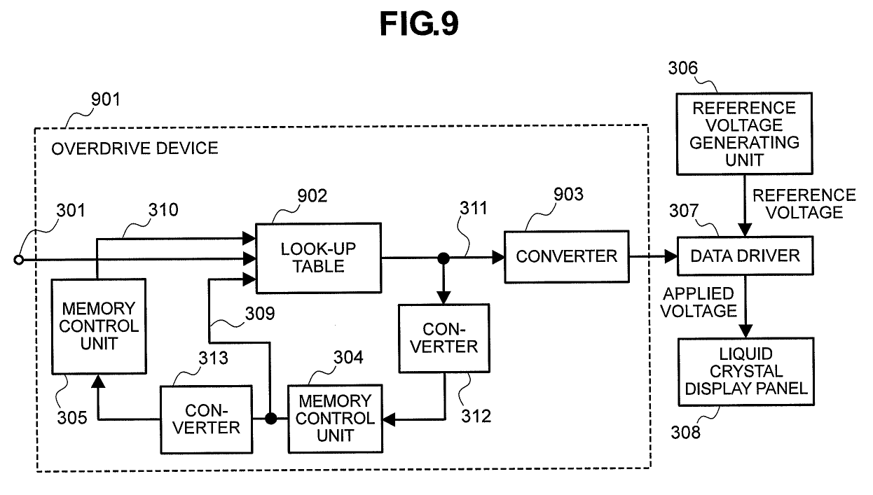

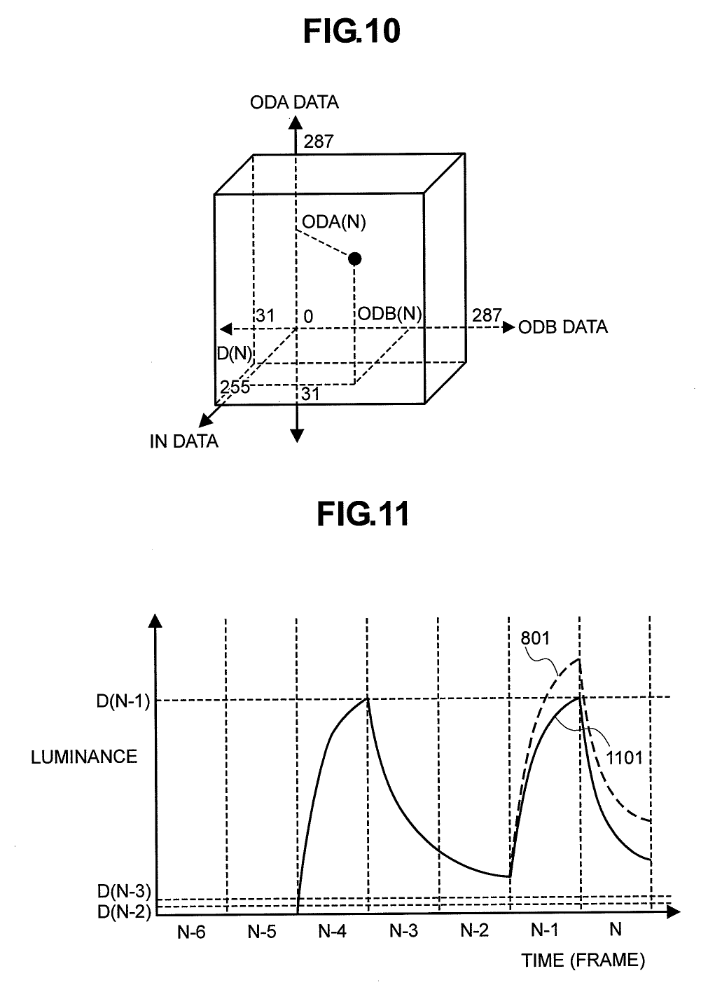

The second embodiment of the invention will be explained with reference to FIG. 7 to FIG. 11. FIG. 7 shows a graph of video data in which the horizontal axis is time (frame) and divergence is concerned at the time of executing the first embodiment, which corresponds to the pixel (m, n) on the liquid crystal display panel 308, FIG. 8 is a graph of liquid crystal response corresponding to the video data of FIG. 5, FIG. 9 is a block diagram showing a configuration of a display device used when executing the embodiment, FIG. 10 is a configuration diagram of a look-up table 902 of FIG. 9, and FIG. 11 is a graph of liquid crystal response when executing the second embodiment with respect to the video data of FIG. 7. In the embodiment, hereinafter, tone information included in display data is dealt with as 255 tones for convenience of explanation, however, any tone value can be treated if the value is an integer of 1 or more.

First, divergence phenomenon concerned when executing the first embodiment will be explained with reference to FIG. 7 and FIG. 8. In FIG. 7, Dmn(N-6), Dmn(N-5) are respectively 0 tone, Dmn(N-4) is p-tone (p is an ingeter satisfying 8<p<255), Dmn(N-3), Dmn(N-2) are respectively q-tone (q is an integer satisfying 0<1<8), r-tone (r is an integer satisfying 0<r<q<8), and the condition of Dmn(N-1)=Dmn(N-4), Dmn(N)=Dmn(N-2) is satisfied. With respect to video data of FIG. 7, the condition of ODmn(N-3)=ODmn(N-2)=0 is satisfied by q, r having values in the vicinity of “0”.

Turning attention to the (N-4)th frame, ODmn(N-4) is outputted by referring to Dmn(N-4), ODAmn (N-4) and ODBmn(N-4) using the look-up table 902, and liquid crystal response reaches luminance corresponding to Dmn(N-4). However, in the next the (N-3)th frame and the (N-2)th frame, IN data indicates tone values in the vicinity of 0 tone, therefore, it is difficult to optimize OD data and the liquid crystal does not reach the desired luminance as described in the problems of the related art. As a result, a reaching tone of liquid crystal response in the (N-2)th frame will be large value as compared with Dmn (N-2). In this case, turning attention to the (N-1)th frame, ODmn (N-1) is outputted by referring Dmn (N-1), ODAmn(N-1), and ODBmn(N-1), however, ODmn(N-1)=ODmn(N-4) from a relational expression of ODAmn(N-1), Dmn(N-2)=0, ODBmn(N-1)=Dmn(N-3)=0 and Dmn(N-1)=Dmn(N-4), therefore, liquid crystal response in the (N-1)th frame exceeds Dmn(N-1) as shown by 801 in FIG. 8 when considering the start luminance (=reaching luminance in the (N-2)th frame). In this case, in the case that IN data of p-tone and IN data of r-tone are alternately inputted repeatedly after the N-frame, the difference between the desired luminance and reaching luminance of liquid crystal with respect to each frame gradually becomes large, which does not realize high picture quality.

Hereinafter, operation of the second embodiment will be explained in detail.

First, respective blocks included in a display device of FIG. 9 will be explained.

An overdrive device 901 is an overdrive device which is improved from the overdrive device 302 used in first embodiment, 902 denotes a look-up table which is improved from the look-up table 303 used in the first embodiment, 903 denotes a converter which converts the bit number of OD data transferred from the look-up table 902, and other blocks are the same as the components of first embodiment shown in FIG. 3, therefore, the same numerals as in FIG. 3 are putted thereto.

Hereinafter, configurations of the overdrive device 901, the look-up table 902 and the converter 903 will be explained.

The overdrive device 901 has a function of acquiring OD data from the look-up table 902 including ID data, ODA data and ODB data and outputting OD data to the data driver 307 in the same manner as the first embodiment.

The look-up table 902 is formed by a three-dimensional map of IN data, ODA data and ODB data as same as the first embodiment. In the embodiment, tone information included in IN data is 8-bit from 0 tone to 255 tone, however, tone information included in ODA data and ODB data is 9-bit from −31 tone to 287 tone. It is also preferable to be 10-bit or more, not limited to 9-bit. The dynamic range of the tone is expanded with respect to the dynamic range of the tone in IN data by 32 tones in the lower tone direction and 32 tones in the higher tone direction. According to the three-dimensional map, OD data for driving the liquid crystal display panel 308 including tone information from −31 tone to 287 tone is acquired by referring to IN data, ODA data, and ODB data respectively, and the data is transferred to the converter 903 and the memory control unit 304. Particularly, OD data before being inputted to the converter 903 is transferred to the memory control unit 304 and the memory control unit 305, therefore, ODA data and ODB data will be 9-bit.

The converter 903 converts 9-bit tone information into 8-bit tone information so that tone values of 255 tone or more is outputted at the 255 tone, tone values of 0 or less is outputted at the 0 tone, and an X tone (X is an integer satisfying 0<X<255) is outputted as it is in OD data transferred from the look-up table 902, and the data is transferred to the data driver 307. That is to say, the dynamic range of reference voltages generated at the reference voltage generating unit 306 corresponds to only the dynamic range from 0 tone to 255 tone, therefore, the converter 903 cuts data exceeding the dynamic range of original tones and restores the data.

According to the above, the second embodiment of the invention is executed at the same operation timing as the first embodiment.

The liquid crystal response with respect to video data of FIG. 5 when executing the second embodiment will be explained with reference to FIG. 8 and FIG. 11 as follows.

In the first embodiment, ODmn(N-1) is acquired on the assumption that liquid crystal response in the (N-2) the frame reaches luminance corresponding to 0 tone, therefore, the reaching luminance does not agree with the desired luminance in the (N-1) frame. In the case of the second embodiment, reaching luminance of liquid crystal response in the (N-2)th frame is calculated from the difference between ODBmn(N-1) (tone value of less than 0 tone) and 0 tone transferred to the data driver 307, and ODmn (N-1) acquiring desired luminance in the (N-1)th frame is acquired from the look-up table 902 as shown by 1101 in FIG. 11, thereby preventing divergence. In the embodiment, the case in which ODBmn(N-1) is 0 tone or less is dealt with, however, the embodiment is available in the case of 255 tone or more.

### Embodiment 3

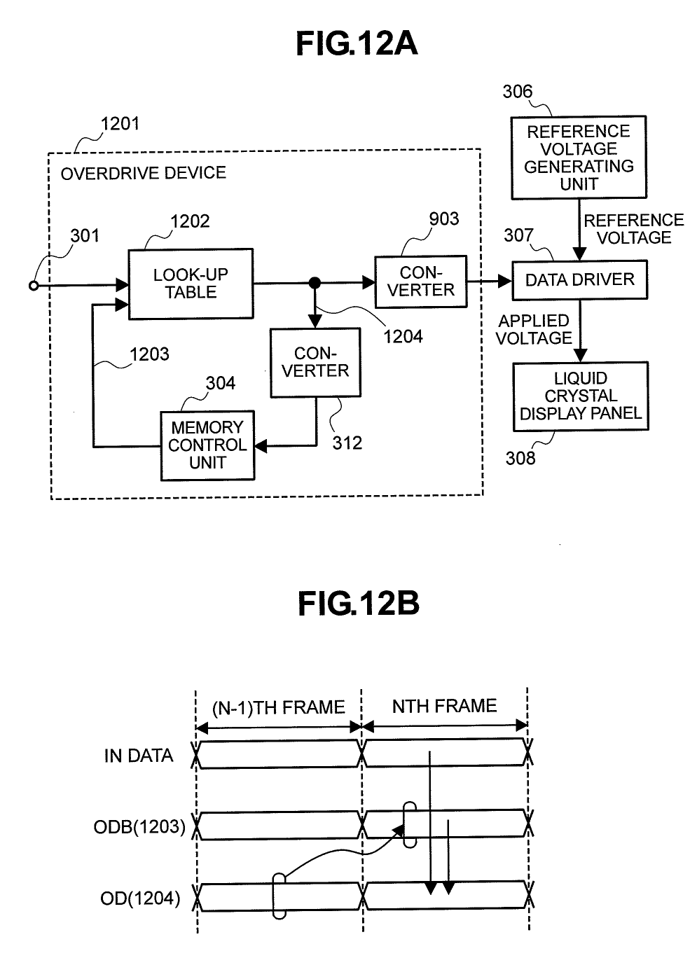

Next, a configuration of the third embodiment of the invention will be explained with reference to FIG. 12 to FIG. 14.

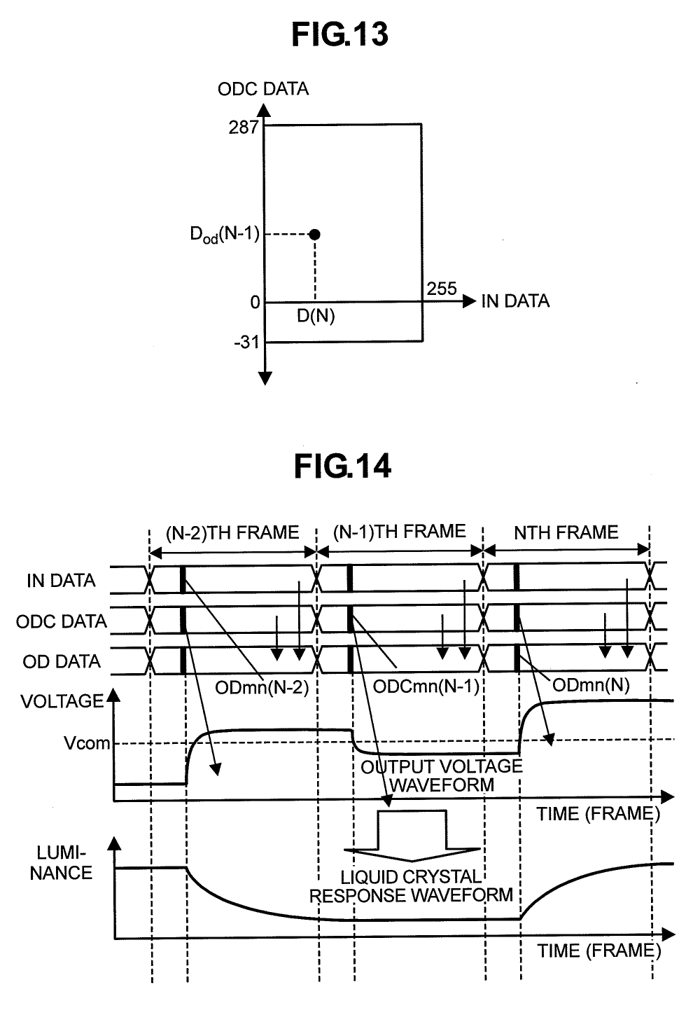

The third embodiment of the invention aims to reduce the circuit scale of the overdrive device as compared with the second embodiment in addition to the prevention of divergence as described above. FIG. 12A is a block diagram showing a configuration of a display device used when executing the embodiment, in which 1201 denotes an overdrive device used in the third embodiment, 1202 denotes a look-up table, 1203, 1204 respectively show data buses. The other blocks are the same as components of the second embodiment shown in FIG. 9, therefore, same numerals are put thereto. FIG. 12B shows a timing chart of overdrive data to be acquired and reference data included in the look-up table 1202. FIG. 13 is a configuration diagram of the look-up table 1202 and FIG. 14 shows the operation timing in the overdrive device 1201. In the embodiment, tone information included in display data is dealt with as 255 tones (corresponding to 8-bit) for convenience of explanation in the same manner as the second embodiment, however, any tone value can be treated if the value is an integer of 0 or more.

According to the above, configurations of the overdrive device 1201 and internal blocks thereof will be explained in detail.

The overdrive device 1201 has a function of transferring OD data from the look-up table 1202 to the data driver 307 based on IN data transferred from the input video terminal 301 to the look-up table 1202 and overdrive data (hereinafter, represented as ODC data) transferred from the memory control unit 304 to the look-up table 1202. In the overdrive device 1201, ODC data is transferred to the data bus 1203, and OD data is transferred to the data bus 1204, respectively. From that point, they are expressed as ODC (1203) and OD (1204) in the timing chart of FIG. 12B.

The look-up table 1202 is formed of a two-dimensional map of IN data and ODC data as shown in FIG. 13. ODC(N) shows ODC data which is referred to for acquiring OD data in the Nth frame. The tone information included in IN data is 8-bit from 0 tone to 255 tone, whereas, the tone information included in ODC data is 9-bit from −31 tone to 287 tone. According to the two-dimensional map, OD data for driving the liquid crystal display panel 308 is acquired by referring to IN data and ODC data respectively, and the data is transferred to the converter 903 and the memory control unit 304. The OD data set in the look-up table 1202 have a value in which correction data corresponding to the difference between IN data and ODC data is added or subtracted to or from the IN data.

Next, the operation timing of the display device in the third embodiment will be explained with reference to FIG. 14.

FIG. 14 is a timing chart of the operation of the above overdrive device 1202, for example, ODmn (N-1) in a pixel (m, n) (1≦m≦I, 1≦n≦J) in the (N-1)th frame is acquired based on Dmn (N-1) and ODCmn(N-1) transferred from the memory control unit 304. Here, ODmn(N-2)=ODCmn(N-1) is satisfied.

According to the above operation, when the third embodiment is executed with respect to video data in FIG. 7, the look-up table 1202 having ODC data in which tone information is expanded is used in the same manner as the second embodiment, thereby acquiring ODmn(N-1) which suppresses divergence and in which liquid response reaches luminance corresponding to Dmn(N-1).

### INDUSTRIAL APPLICABILITY

The display device according to the invention can be applied to a liquid crystal television.

What is claimed is:

1. A display device, comprising:
a display panel;
a driver driving the display panel; and
an overdrive device correcting video data to be inputted to the driver,
wherein the overdrive device corrects inputted video data based on video data of three frames or more including video data inputted to the overdrive device, video data after correction by the overdrive device, which is previous by one frame and video data after correction by the overdrive device, which is previous by two frames.

2. The display device according to claim 1, further comprising:
reference information which defines video data after correction with respect to the inputted video data, the video data after correction which is previous by one frame and the video data after correction which is previous by two frames,
wherein the overdrive device acquires video data after correction by referring to the reference information based on the inputted video data, the video data after correction which is previous by one frame and the video data after correction which is previous by two frames.

3. The display device according to claim 1,
wherein video data after correction by the overdrive device is larger than the inputted video data when the inputted video data is larger than the video data after the correction which is previous by two frames.

4. The display device according to claim 1,
wherein video data after correction by the overdrive device is equal to the inputted video data when the inputted video data is equal to the video data after correction which is previous by two frames.

5. The display device according to claim 1,
wherein video data after correction by the overdrive device when video data after correction which is previous by one frame and video data after correction which is previous by two frames have the minimum value, the inputted video data is larger than the video data after correction which is previous by one frame and the video data after correction which is previous by two frames, the inputted video data which is previous by one frame is equal to the inputted video data which is previous by two frames, and the inputted video data is larger than the inputted video data which is previous by one frame and the inputted video data which is previous by two frames is larger than video data after correction by the overdrive device when the video data after correction which is previous by one frame is larger than the video data after correction which is previous by two frames, the inputted video data is larger than the video data after correction which is previous by one frame and the video data after correction which is previous by two frames, the inputted video data which is previous by one frame is equal to the inputted video data which is previous to two frames, and the inputted video data is larger than the inputted video data which is previous by one frame and the inputted video data which is previous by two frames.

6. The display device according to claim 1,
wherein the overdrive device increases the bit number of the inputted video data with the correction of the inputted video data from X-bit to (X+α)-bit (α is an integer of 1 or more), and
wherein video data after correction by the overdrive device which is previous by one frame and video data after correction by overdrive device by two frames is video data of (X+α)-bit.

7. The display device according to claim 1, further comprising:
a conversion circuit converting the video data of (X+α) -bit after correction of overdrive device into video data of X-bit.

8. A display device, comprising:
a display panel;
a driver driving the display panel; and
an overdrive device correcting video data to be inputted to the driver,
wherein a value of video data displayed on the display panel is different from a value of video data inputted to the display device in the case that values of video data of three frames to be inputted to the display device are the same to one another, however, a value of video data which is previous by one frame to the video data of three frames is different.

9. A display device, comprising:
a display panel;
a driver driving the display panel; and
an overdrive device correcting video data to be inputted to the driver,
wherein a value of video data displayed on the display panel is different from a value of video data inputted to the display device in the case that values of video data of four frames to be inputted to the display device are the same to one another, however, a value of video data which is previous by one frame to the video data of four frames is different.

10. A display device, comprising:
a display panel;
a driver driving the display panel; and
an overdrive device correcting video data to be inputted to the driver,
wherein luminance of video data displayed on the display panel when values of video data of three frames to be inputted to the display device are the same to one another as well as a value of video data which is previous by one frame to the video data of three frames is different is different from luminance of video data displayed on the display panel when the values of video data of four frames to be inputted to the display device are the same with one another.

11. A display device, comprising:
a display panel;
a driver driving the display panel; and
an overdrive device correcting video data to be inputted to the driver,
wherein luminance of video data to be displayed on the display panel when values of video data of four frames to be inputted to the display device are the same with each other as well as a value of video data which is previous by one frame to the video data of four frames is different is different from luminance of video data to be displayed on the display panel when values of video data of five frames to be inputted in the display device are the same to one another.
